(19) United States
(12) Patent Application Publication
(10) Pub. No.: US 2006/0001886 A1
(43) Pub. Date: Jan. 5, 2006

(54) Precision retroreflector positioning apparatus

(75) Inventors: Donald Frank Zacharie, Sunnyvale, CA (US); Paul Vincent Mammini, Rocklin, CA (US)

Correspondence Address: MCDERMOTT WILL & EMERY LLP, 18191 VON KARMAN AVE., SUITE 400, IRVINE, CA, 92612-7107, US

(73) Assignee: Lockheed Martin Corporation, Bethesda, MD (US)

(21) Appl. No.: 10/880,522

(22) Filed: Jul. 1, 2004

(51) Int. Cl. G01B 9/02

(52) U.S. Cl. 356/486

(57) ABSTRACT

An apparatus for positioning a retroreflector. The apparatus includes a retroreflector, where the retroreflector further includes an effective aperture. The apparatus also includes a retroreflector mount for holding the retroreflector, where the retroreflector mount further includes a front end and a back end obverse to the front end, where the effective aperture is exposed through an opening in the front end. The apparatus further includes a plurality of parallel radial flexures including a first radial flexure and a second radial flexure parallel to the first radial flexure, where the first radial flexure surrounds the front end, and where the second radial flexure surrounds the back end. Additionally, the apparatus includes an actuator for positioning the retroreflector, where the plurality of parallel radial flexures allow for one-axis movement of the retroreflector of ±2.5 millimeters perpendicular to the plurality of parallel radial flexures, with an axial deviation of less than 0.001 radians.

### STATEMENT AS TO RIGHTS TO INVENTIONS MADE UNDER FEDERALLY SPONSORED RESEARCH OR DEVELOPMENT

Not Applicable

### FIELD OF THE INVENTION

The present invention relates generally to positioning of optical elements within an optical system, and more particularly relates to the precise positioning of a retroreflector along one axis, with minimal axial deviations.

### BACKGROUND OF THE INVENTION

In certain optical applications, it is desirable to precisely control the path distance between a light source and a reflective element. It is particularly desirable to precisely and repeatedly control the position of an optical element along a first axis relative to a fixed light source, without appreciably displacing the mirror along dimensions orthogonal to the first axis.

One specific optical application relating to high precision positioning involves the use of corner-cube retroreflectors. A corner-cube retroreflector is a prism or set of three first-surface mirrors each having three mutually perpendicular surfaces and a hypotenuse face, or effective aperture. Light entering through the effective aperture is reflected by each of the three surfaces, and emerges back through the effective aperture parallel to the entering beam.

As depicted in FIG. 1, a conventional laser heterodyne interferometer can be used as a metrology gauge to measure the distance L between corner-cube retroreflector 101 and corner-cube retroreflector 102. Briefly, changes in the relative phase between signals received at reference photodiode 104 and measurement photodiode 105, and reference photodiode 106 and measurement photodiode 107 are measured to calculate the optical path difference (“OPD”) between reference light beam 109 and a measurement light beam 110. Through a series of known optical equations, computer 111 can calculate the change in distance between the corner-cube retroreflector 101 and corner-cube retroreflector 102 using the OPD. See Peter G. Halverson & Robert E. Spero, Signal Processing and Testing of Displacement Metrology Gauges with Picometer-Scale Cyclic Nonlinearity, J. of Optics A: Pure and Applied Optics, Vol. 4, No. 6 (November 2002).

Interferometric displacement gauges, such as the laser heterodyne interferometer discussed above, are typically susceptible to various errors, including but not limited to cyclic error, diffraction error, mispointing, thermal drift, laser drift, and errors introduced from other noise sources. As illustrated in FIG. 2, cyclic error is exhibited by known interferometric displacement gauges as a repeatable non-linearity when the distance measured is varied. This non-linearity is typically a sinusoidal deviation from expected measurements, when the distance between the corner-cube retroreflectors is adjusted linearly.

Reverting to FIG. 1, there are several sources of cyclic error in conventional laser heterodyne interferometer metrology gauges, including:
Frequency shifters & RF leakage (Region A): After exiting laser 112, the gauge's laser light is split into two paths, and the frequency is shifted to create two optical frequencies by acousto-optic modulator (“AOM”) 114 and AOM 115. Mixing of the radiofrequency (“RF”) signals creates a predictable cyclic error.
Metrology head & optical leaking (Region B): Leakage of the reference beam or measurement beam into unintended paths near metrology head 116 or metrology head 117 will cause a cyclic error.
Photodiode signal mixing (Region C): Electrical isolation is achieved by operating with photodiode preamps, filter and sine-to-square wave converters 119 to 122 on independent power supplies, and by preventing ground loops.
Timing signal mixing (Region D): The outputs of sine-to-square-wave converters 119 to 122 are inherently immune to cross-talk effects.
Phasemeter time-of-measurement error (Region E): The phasemeter measures the relative time of logic transitions signaling the zero-crossings of the photodiode signals. This creates ambiguity as to when phase measurements are made.

Since cyclic error is manifested as a periodic deviation from the linear ramp expected when constant velocity motion is applied to a fiducial (such as a corner-cube retroreflector), these periodic deviations can be used for detecting and measuring the cyclic error. FIG. 3 is a simplified block diagram illustrating one such typical cyclic error measurement test bed.

During cyclic error measurement, corner cube retroreflector 301 is moved linearly along the Z-axis, or parallel to the axis defined by laser beam 302 of a known frequency, emitted from laser 303. The displacement time history is measured by displacement measuring interferometer 304, and virtual machine environment (“VME”) chassis 305 applies a Fourier transform to the output data to reveal the cyclic error at the frequency. Typically, corner-cube retroreflector 301 is positioned using a Z-axis coupler control loop, which includes lead-zirconate-titanate (“PZT”) actuator 306 connected to the backside surface of corner-cube retroreflector 301 via a coupler. Fold mirror 308 directs laser beam 302 from laser 303 to corner-cube retroreflector 301, and a ramp generator (not depicted) transmits a signal to PZT actuator 306 to control the linear motion of corner-cube retroreflector 301.

In order to avoid coupling or beam walk errors, the X-axis and Y-axis motion of the corner cube retroreflector must be minimized. If axial deviations occur during positioning of the corner cube retroreflector, displacement measurement errors will occur, and calculated cyclic error will be greater than actual cyclic errors. Typical couplering mechanisms exhibit deviations of straightness of motion and tilt, including undesirable pitch, yaw, and roll, resulting in Abbe error and Cosine error.

It is therefore considered highly desirable to provide an apparatus for precisely positioning or moving a reflective optical element, to repeatedly control the position of the reflective optical element along an axis defined by the light beam, while minimizing deviations orthogonal to that axis. In particular, it is desirable to provide an apparatus for positioning a corner-cube retroreflector along an axis parallel to a beam of light, while minimizing axial deviations.

### SUMMARY OF THE INVENTION

Various optical applications require the precise movement or positioning of a retroreflector in one dimension, while minimizing axial deviations. Conventional positioning apparatus, however, typically exhibit off-axis motion, introducing errors. The present invention solves the foregoing problems by providing precise positioning of a retroreflector along one axis, with minimal axial deviations.

According to one aspect, the present invention is an apparatus for positioning a retroreflector. The apparatus includes a retroreflector, where the retroreflector further includes an effective aperture. The apparatus also includes a retroreflector mount for holding the retroreflector, where the retroreflector mount further includes a front end and a back end obverse to the front end, and where the effective aperture is exposed through an opening in the front end. Furthermore, the apparatus also includes a plurality of parallel radial flexures including a first radial flexure and a second radial flexure parallel to the first radial flexure, where the first radial flexure surrounds the front end, and where the second radial flexure surrounds the back end, and an actuator for positioning the retroreflector. The plurality of parallel radial flexures allow for one-axis movement of the retroreflector of ±2.5 millimeters perpendicular to the plurality of parallel radial flexures, with an axial deviation of less than 0.001 radians.

Since the precision retroreflector apparatus of the present invention includes a plurality of parallel radial flexures, an actuator which applies a force on the retroreflector mount at the center of the flexures effectuates a movement along one axis.

The first radial flexure is preferably comprised of steel, aluminum, Invar or titanium, and the actuator is preferably a PZT actuator, voice-coil actuator, piezo actuator, or linear motor. The apparatus further includes a coupler, where the coupler connects the actuator to the back end of the retroreflector mount. The stiffness of the flexures allows the retroreflector to be positioned over a 5 millimeter range (2.5 millimeters in each direction), without introducing axial deviations of greater than a milli-radian.

The first radial flexure is pinned and clamped to the retroreflector mount. The first radial flexure includes a notched cutout pattern, or a spiral cutout pattern. To its benefit, the apparatus according to the present invention uses a plurality of parallel radial flexures to provide repeatable, 1-axis range and resolution, with precision not available to conventional, “off the shelf” couplering mechanisms. As such, the apparatus can position an optical or non-optical object to a greater precision and repeatability than other conventional linear translation stages.

According to a second aspect, the present invention is a precision positioning apparatus, including a mount, where the mount further includes a front end and a back end obverse to the front end. The apparatus also includes a plurality of parallel radial flexures including a first radial flexure and a second radial flexure parallel to the first radial flexure, where the first radial flexure surrounds the front end, and where the second radial flexure surrounds the back end. The apparatus further includes an actuator for positioning the mount, where the plurality of parallel radial flexures allow for one-axis movement of the mount of ±2.5 millimeters perpendicular to the plurality of parallel radial flexures, with an axial deviation of less than 0.001 radians.

In the following description of the preferred embodiment, reference is made to the accompanying drawings that form a part thereof, and in which is shown by way of illustration a specific embodiment in which the invention may be practiced. It is to be understood that other embodiments may be utilized and changes may be made without departing from the scope of the present invention.

### BRIEF DESCRIPTION OF THE DRAWINGS

Referring now to the drawings in which like reference numbers represent corresponding parts throughout:

FIG. 1 depicts a block diagram of a typical laser heterodyne interferometer;

FIG. 2 is a chart illustrating cyclic error of a typical laser heterodyne interferometer, shown as a sinusoidal deviation from an expected measurement as the distance between fiducial elements is adjusted linearly;

FIG. 3 depicts a typical component layout for the detection and measurement of cyclic error;

FIG. 4 depicts a cross-sectional view of the apparatus for positioning a retroreflector, according to one embodiment of the present invention;

FIG. 5 illustrates a frontal view of the FIG. 2 embodiment;

FIG. 6 shows a perspective view of the FIG. 2 embodiment;

FIGS. 7A and 7B illustrate a cross-sectional view of the apparatus for positioning a retroreflector, in a state where the retroreflector mount has been projected and retracted, respectively;

FIGS. 8 and 8A depict a frontal view and a side view, respectively, of an example notched radial flexure used by the apparatus according to one embodiment of the present invention;

FIGS. 9 and 9A depict a frontal view and a side view, respectively, of an example spiral-cut radial flexure used by the apparatus according to an alternate embodiment of the present invention;

FIG. 10 is a drawing of a cyclic error measurement test bed, including the apparatus for apparatus for positioning a retroreflector according to the FIG. 2 embodiment of the present invention; and

FIG. 11 is a depiction of a 2-gauge test bed for detecting cyclic error, using the FIG. 2 embodiment of the present invention.

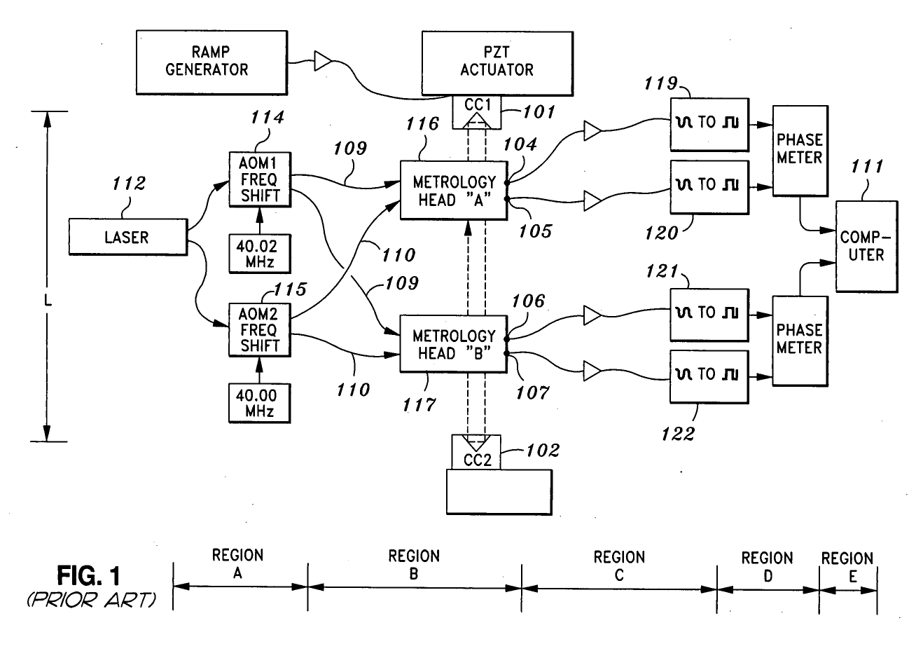

### DETAILED DESCRIPTION OF THE INVENTION

The present invention allows for the precision positioning of a retroreflector by an actuator, by surrounding a retroreflector mount with a plurality of parallel radial flexures.

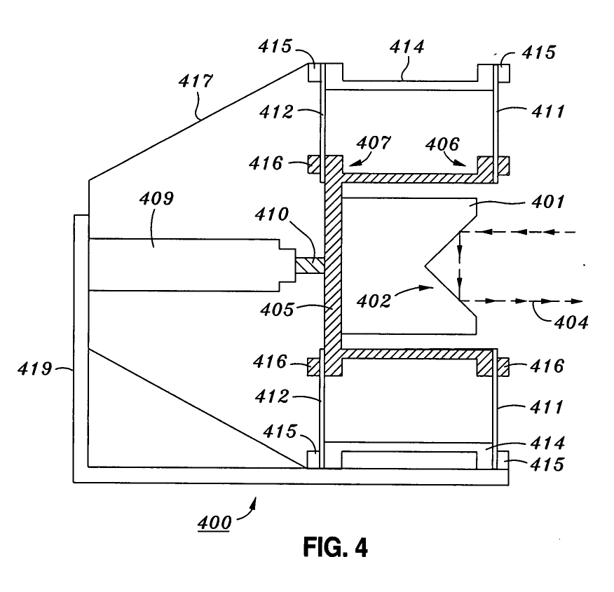

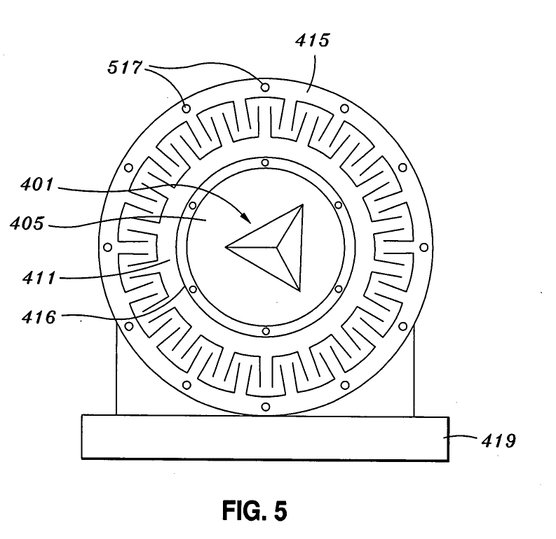

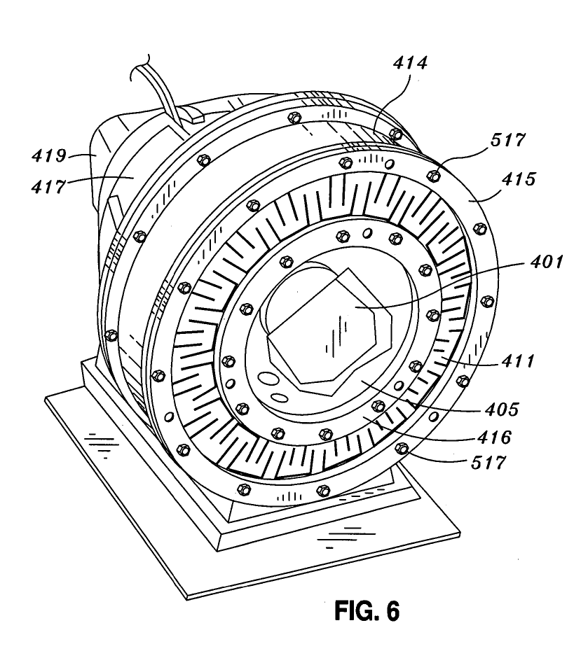

FIG. 4 is a cross-sectional view of one embodiment of an apparatus for positioning a retroreflector, in accordance with the present invention. FIG. 5 is a frontal view of the apparatus for positioning a retroreflector of FIG. 4, and FIG. 6 is a perspective view of the same apparatus.

Briefly, the embodiment of the present invention illustrated in FIGS. 4 to 6 relates to an apparatus for positioning a retroreflector, where the apparatus includes a retroreflector, and where the retroreflector further comprises an effective aperture. The apparatus also includes a retroreflector mount for holding the retroreflector, where the retroreflector mount further includes a front end and a back end obverse to the front end, where the effective aperture is exposed through an opening in the front end. Additionally, the apparatus includes an actuator for positioning the retroreflector, and a plurality of parallel radial flexures including a first radial flexure and a second radial flexure parallel to the first radial flexure, where the first radial flexure surrounds the front end, and where the second radial flexure surrounds the back end. The plurality of parallel radial flexures allow for one-axis movement of the retroreflector of +2.5 millimeters perpendicular to the plurality of parallel radial flexures, with an axial deviation of less than 0.001 radians.

In more detail, apparatus 400 for positioning a retroreflector includes retroreflector 401, where retroreflector 401 further includes effective aperture 402. A retroreflector is a device which transmits light back to where it came from, regardless of the angle of incidence. As depicted in FIG. 4, light beam 404 enters effective aperture 402 and, due to the geometry of retroreflector 401, light beam 404 is reflected back at the light source in a beam parallel to the incoming beam.

Apparatus 400 also includes retroreflector mount 405, where retroreflector mount further includes front end 406 and back end 407 obverse to front end 406. Effective aperture 402 is exposed through an opening in front end 406. Retroreflector mount 405 is for holding retroreflector 401, and allows for retroreflector 401 to be moved through one-axis motion with minimal axial deviations.

As illustrated in FIGS. 4 to 6, apparatus 400 further includes actuator 409 and coupler 410 for positioning retroreflector 401, by applying a positioning force to retroreflector mount 405. Actuator 409 is a PZT actuator, although in alternate arrangements actuator 409 is another type of actuator known in the art to be effective for nanopositioning, such as a piezo actuator, voice coil actuator or a linear motor. The net force applied by actuator 409 is directed to the center of retroreflector mount 405.

In an additional alternate aspect of the present invention, coupler 410 is omitted, and actuator 409 applies positioning forces to retroreflector mount 405 directly. Retroreflector mount 405 remains in a stable, neutral position when actuator 409 is not applying a positioning force.

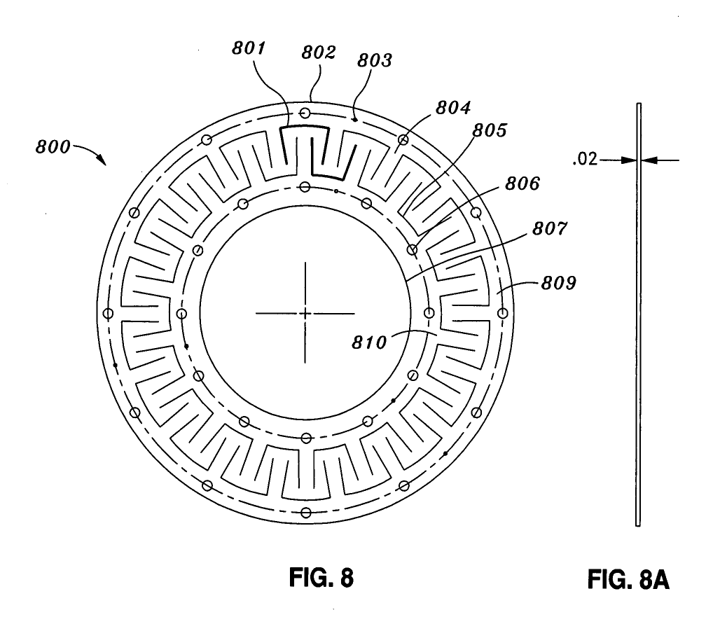

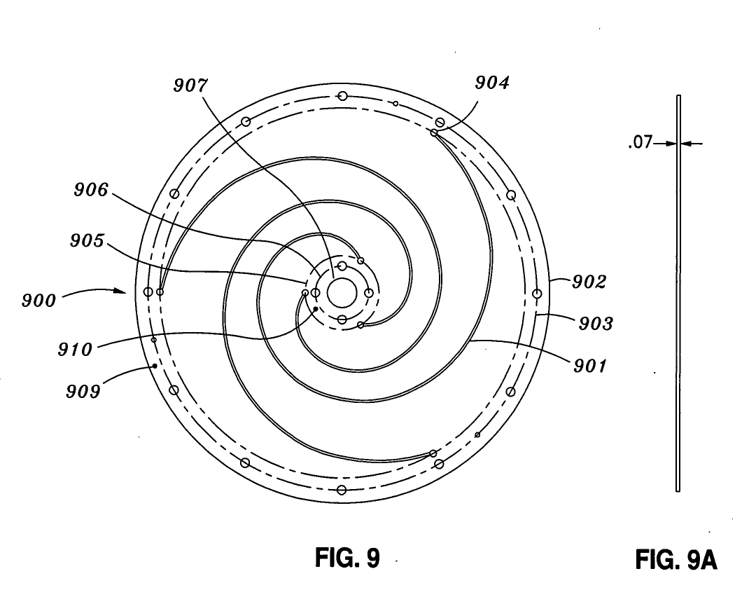

Apparatus 400 includes a plurality of parallel radial flexures, including first radial flexure 411 and second radial flexure 412 parallel to first radial flexure 411. First radial flexure 411 surrounds front end 406, and second radial flexure 412 surrounds back end 407. First radial flexure 411 and second radial flexure 412 are in physical communication with both retroreflector mount 405 and support 414, and hold retroreflector mount 405 into place. The structure, composition and design of the radial flexures will be discussed in more detail in conjunction with the descriptions of FIGS. 8 and 9.

Support 414 and retroreflector mount 405 hold the plurality of parallel radial flexures in place by clamping. Specifically, as illustrated in FIGS. 4 and 5, a radial flexure is placed in between support 414 and outer clamp 415, or retroreflector mount 405 and inner clamp 416, and the flexure is clamped by securing outer clamp 415 or inner clamp 416 into place using bolts 517 (FIG. 5). In an alternate, aspect of the invention, the plurality of parallel radial flexures is held in place by pinning and clamping.

Finally, apparatus 400 also includes shell 417 for protecting actuator 409 and coupler 410 from external influences, and frame 419, upon which all the above described components are mounted.

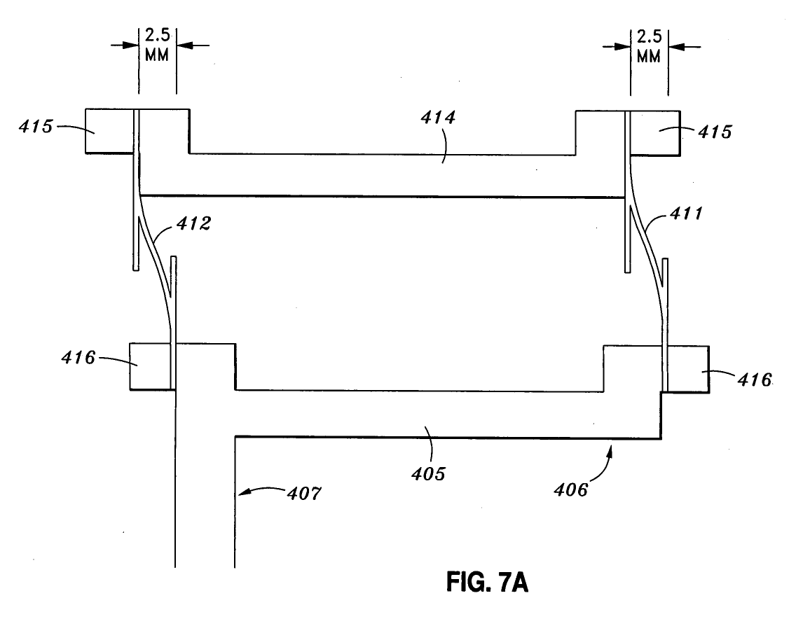

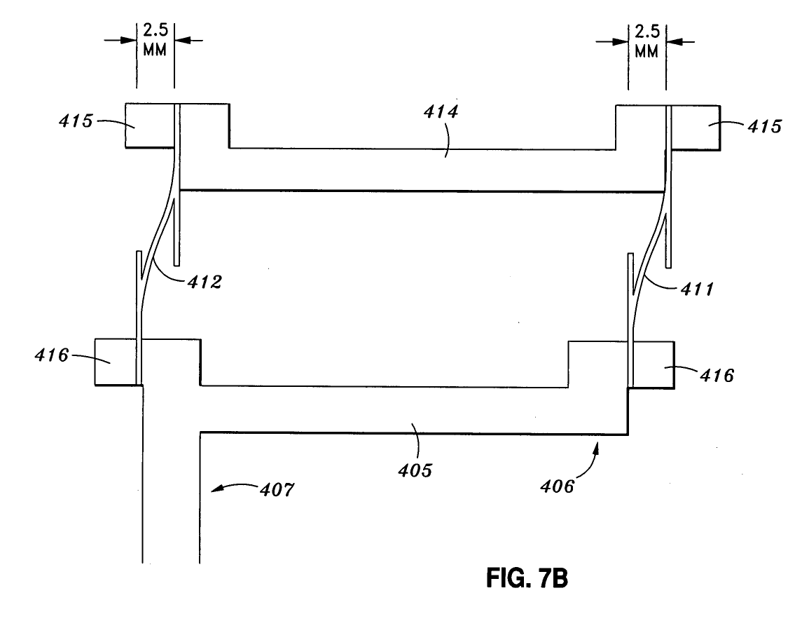

FIGS. 7A and 7B illustrate an enlarged, cross-sectional view of the apparatus for positioning a retroreflector, in a state where the retroreflector mount has been projected and retracted, respectively. Referring briefly to FIG. 4, actuator 409 pushes coupler 410, and coupler 410 applies a one-axis force on retroreflector mount 405 perpendicular to second radial flexure 412. As shown in FIG. 7A, the force is directed to a location on back end 407 representing the radial center of second radial flexure 412. In a similar manner, the same one-axis force is transmitted via retroreflector mount 405 to front end 406, which moves perpendicular to first radial flexure 411 as well.

Retroreflector mount 405, which holds retroreflector 401, can be projected up to +2.5 millimeters from a neutral position, with an axial deviation of less than 0.001 radians. By projecting retroreflector 401, apparatus 400 effectuates a shortened laser beam path length.

In FIG. 7B, actuator 409 pulls coupler 410, and coupler 410 applies a one-axis force on retroreflector mount 405 perpendicular to second radial flexure 412, and in an obverse direction to the force applied in FIG. 7A. The force applied by coupler 410 and actuator 409 is directed to a location on back end 407 representing the radial center of second radial flexure 412. Similarly, the one-axis force is transmitted via retroreflector mount 405 to front end 406, which moves perpendicular to first radial flexure 411.

Retroreflector mount 405 and retroreflector 401 can be retracted up to −2.5 millimeters from the neutral position, with an axial deviation of less than 0.001 radians. By retracting retroreflector 401, apparatus 400 effectuates a longer laser beam path length.

FIG. 8 depicts a frontal view of an example “notched” radial flexure used by the apparatus according to one embodiment of the present invention. The radial flexure 800 includes a series of 18 sets of overlapping notch-shaped cuts, including cutout 801, around the periphery of flexure 800, allowing flexure 800 to provide for one-axis motion orthogonal to the plane defined by flexure 800, with minimal axial deviation.

The features of the notched radial flexure 800 are oriented on six discrete rings 802 to 807. Ring 802, the outermost ring, defines the outer perimeter of radial flexure 800, and has a relative diameter of 8.50 units. The next smallest ring, ring 803, defines a circle around which bolts and pins are inserted to hold outer clamp 415 onto support 414, thereby clamping flexure 800 into place. Ring 803 has a relative diameter of 8.00 units.

Ring 804 and ring 805, respectively, define the outer radius and the inner radius of the notch cuts. Ring 804 has a relative diameter of 7.50 units, and ring 805 has a relative diameter of 5.5 units. Ring 806 is similar in function to ring 803, and defines a circle around which bolts and pins are inserted to hold inner clamp 416 onto retroreflector mount 405, in order to clamp flexure 800 into place. Ring 806 has a relative diameter of 5.00 units. Finally, ring 807, the smallest ring with a relative diameter of 4.30 units, defines the inner perimeter of radial flexure 800.

Outer flexure portion 809 lies between ring 802 and ring 804, and inner flexure portion 810 lies between ring 805 and ring 807. As a result of the freedom of movement imparted by the presence of the overlapping notch-shaped cuts such as cutout 801, inner flexure portion 810 can be can be displaced with respect to outer flexure portion 809, in a direction orthogonal to the plane defined by flexure 800 up to 2.5 millimeters in each direction (for a total range of 5 millimeters), with an axial deviation of less than 0.001 radians.

Flexure 800 is comprised of Invar, although in an alternate aspect of the present invention flexure 800 is comprised of steel, aluminum, or titanium. Cutout 801 is formed by chemical etching, laser cutting, electro discharge machining (“EDM”) or other machining processes known in the art. Each cutout includes an arc-shaped portion, oriented on either ring 804 or ring 805, and two straight-radial portions oriented relative to the center of the flexure, and each intersecting an obverse end of the arc-shaped portion.

A finite element model (“FEM”) study was developed using the flexure design depicted in FIG. 8, with flexures comprised of Invar, steel, and aluminum. Table 1 shows the results of the FEM, which compares total weight, active weight, axial spring constant (Kₐₓᵢₐₗ), lateral spring constant (Kₗₐₜₑᵣₐₗ), lateral frequency (fₗₐₜₑᵣₐₗ), and axial frequency (fₐₓᵢₐₗ) for each of four different configurations:

TABLE 1
FEM Results

| | | | | | | | Aluminum, | |
|---|---|---|---|---|---|---|---|---|
| | Steel, pinned | | Steel, clamped | | Invar, clamped | | clamped | |
| Total weight | 0.0957168 | lb | 0.0957168 | lb | 0.1009188 | lb | 0.033986 | lb |
| Active weight | 0.0478587 | lb | 0.0478587 | lb | 0.0504594 | lb | 0.016933 | lb |
| Kₐₓᵢₐₗ | 126.34175 | lb/in | 505.155108 | lb/in | 365.843397 | lb/in | 176.5514 | lb/in |
| Kₗₐₜₑᵣₐₗ | 2.99709 E 5 | lb/in | 3.0455214 E 5 | lb/in | 2.19574 E 5 | lb/in | 1.05942 E 5 | lb/in |
| ƒₐₓᵢₐₗ | 160.7434 | Hz | 321.4199 | Hz | 266.388 | Hz | 318.889 | Hz |
| ƒₗₐₜₑᵣₐₗ | 7.829 | kHz | 7.892 | kHz | 6.52617 | kHz | 7.811596 | kHz |

While FIGS. 4 to 8 and their accompanying descriptions fully describe a specific embodiment of the present invention, various modifications, alternative constructions and equivalents may be used. For example, while the example embodiment illustrated in FIGS. 4 to 8 utilizes a pair of flexures having a specific notched cutout pattern, this pattern is not required by alternate embodiments of the present invention. In accordance with these alternate embodiments, other flexure designs or additional flexures can be used.

For instance, FIG. 9 depicts a frontal view of an example of a spiral-cut radial flexure used by the apparatus according to an alternate embodiment of the present invention. Flexure 900 comprises a metal disk, in which a series of 3 spiral cutouts, including spiral cutout 901, are formed, allowing flexure 900 to provide for one-axis motion orthogonal to the plane defined by flexure 900, with minimal axial deviation.

The features of the radial flexure 900 are oriented on six discrete rings. Ring 902, the outermost ring, defines the outer perimeter of radial flexure 900, and has a relative diameter of 8.50 units. The next smallest ring, ring 903, defines an circle around which bolts and pins are inserted to hold outer clamp 415 onto support 414, thereby clamping flexure 900 into place. Ring 903 has a relative diameter of 8.00 units.

The start point and end point of cutout 901 lie on ring 904 and ring 905, respectively. Ring 904 has a relative diameter of 7.50 units, and ring 905 has a relative diameter of 1.5 units. Ring 906 is similar in function to ring 902, and defines a circle around which bolts and pins are inserted to hold inner clamp 416 onto retroreflector mount 405, in order to clamp flexure 900 into place. Ring 906 has a relative diameter of 1.06 units. Finally, ring 907, the smallest ring with a relative diameter of 0.62 units, defines the inner perimeter of radial flexure 900.

Flexure 900 is comprised of Invar, although in an alternate aspect of the present invention flexure 900 is comprised of steel, aluminum or titanium. Cutout 901 is formed by chemical etching, laser cutting or other machining processes known to the art. Each cutout begins on ring 904, and makes a spiral pattern, ending on ring 905.

Outer flexure portion 909 lies between ring 902 and ring 904, and inner flexure portion 910 lies between ring 905 and ring 907. As a result of the freedom of movement imparted by the presence of the overlapping spiral-shaped cuts such as cutout 901, inner flexure portion 910 can be can be displaced with respect to outer flexure portion 909, in a direction orthogonal to the plane defined by flexure 900 more than 15 millimeters in each direction (for a total range of 30 millimeters), with a minimal axial deviation.

The spiral-shaped flexure design shown in FIG. 9 offers the advantage of greater length of linear motion orthogonal to the plane defined by the flexures, as compared with the example notched flexure design of FIG. 8. However, displacement of inner flexure portion 910 along this axis of motion will be accompanied by some amount of rotation inner flexure portion 910 relative to outer flexure portion 909. In certain applications, such as where retroreflector 901 is a symmetrical mirror, the rotation would be insignificant. In other applications, however, the rotation is beneficial, since the amount of rotation per displacement distance can be measured and controlled, by adjusting the shapes of the cutouts.

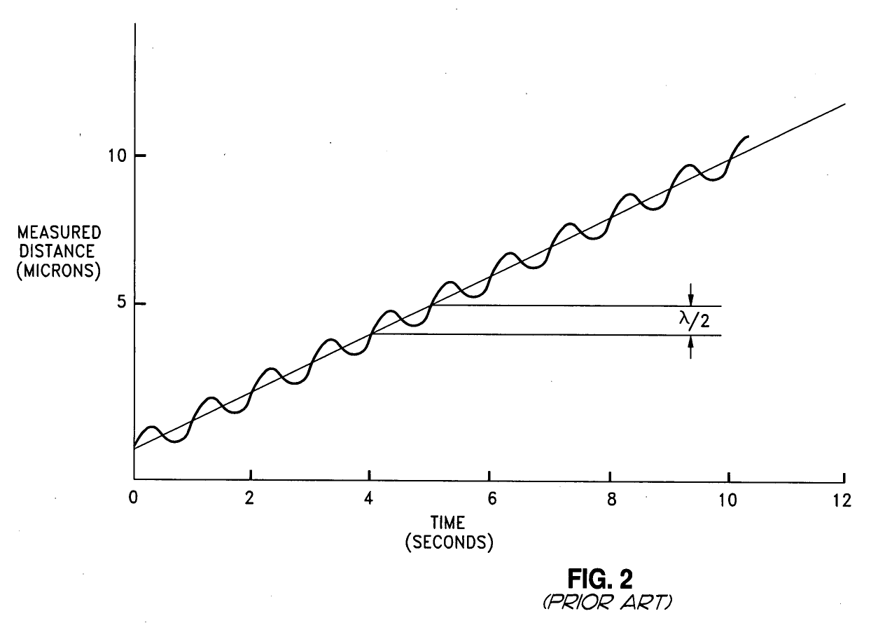

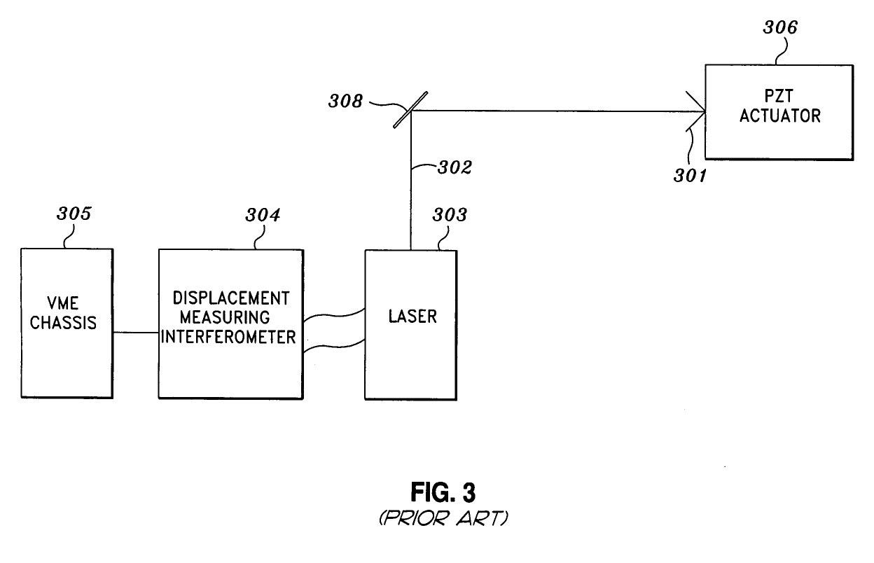

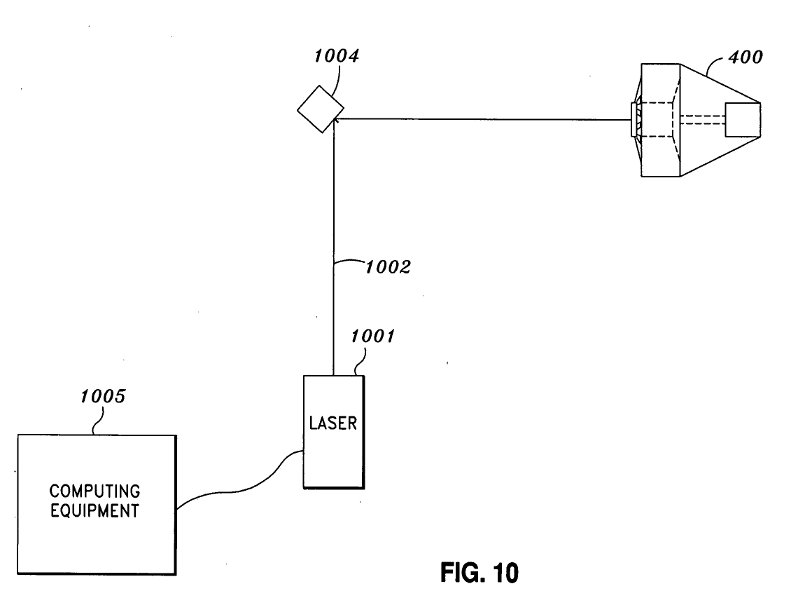

FIG. 10 is a block diagram depicting a cyclic error measurement test bed, including apparatus 400 for positioning a retroreflector according to the FIG. 2 embodiment of the present invention. Specifically and as described above with respect to FIG. 2, apparatus 400 includes a retroreflector, where the retroreflector further comprises an effective aperture, and a retroreflector mount for holding the retroreflector, where the retroreflector mount further includes a front end and a back end obverse to the front end, where the effective aperture is exposed through an opening in the front end. Furthermore, apparatus 400 includes a plurality of parallel radial flexures including a first radial flexure and a second radial flexure parallel to the first radial flexure, where the first radial flexure surrounds the front end, and where the second radial flexure surrounds the back end. Moreover, the apparatus includes an actuator for positioning the retroreflector, where the plurality of parallel radial flexures allow for one-axis movement of the retroreflector of ±2.5 millimeters perpendicular to the plurality of parallel radial flexures, with an axial deviation of less than 0.001 radians.

In addition to apparatus 400, as seen in FIG. 10, the cyclic error measurement test bed further includes laser 1001 for emitting laser beam 1002. Laser beam 1002 reflects off of fold mirror 1004, and laser beam 1002 is directed into the corner-cube retroreflector mounted on apparatus 400. The corner cube retroreflector is moved linearly along the Z-axis, or parallel to the axis defined by laser beam 1002 of a known frequency. The displacement time history is measured by computing equipment 1005, and a Fourier transform is applied to the output data to reveal the cyclic error at the frequency.

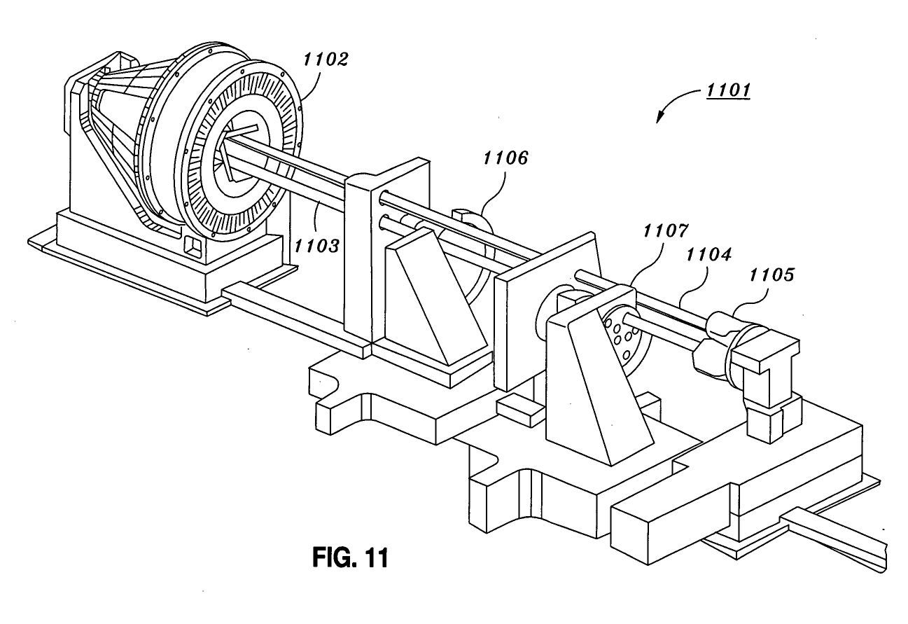

FIG. 11 shows a 2-gauge test bed for detecting cyclic error, using the FIG. 2 embodiment of the present invention. The 2-gauge test bed is used for cyclic error testing, to verify a cyclic error sensitivity of less than or equal to 1 pmᵣₘₛ. The test bed can also be used to verify that thermal sensitivity and corner-cube translation fall within specified parameters. As seen in FIG. 11, 2-gauge test bed 1101 includes precision retroreflector positioning apparatus 1102 for controlling the path length of measurement light beam 1103 and reference light beam 1104 between precision retroreflector positioning apparatus 1102 and corner cube retroreflector 1105. Metrology head 1106 and metrology head 1107 measure the OPD between reference light beam 1104 and a measurement light beam 1103. The OPD is used to calculate the change in distance between the corner-cube retroreflector mounted on precision retroreflector positioning apparatus 1102 and corner-cube retroreflector 1105.

With regard to cyclic error testing, the test bed illustrated in FIG. 11 uses stable mounts and platforms, to reduce environmental interferences so that 1 pm can be observed at 100 Hz. The Z-axis coupler control loop utilizes an optical gauge and/or strain gauges, where the couplering axis is the Z-axis of the reference corner-cubes, and X-axis and Y-axis motion of the corner cubes is restricted to less than 1 μm, to avoid coupling with beam walk errors. An alignment of 1° is maintained between corner cubes with respect to the vertex-to-vertex axis while couplering. The couplering mechanism provides ±25 μm along the Z-axis and Z-axis tip and tilt. Coupler frequency is between 1 to 2 Hz, with a ±25 μm coupler amplitude. The coupler sweep requires a triangle configuration which is as linear as possible. Non-linearities should be identified and used to correct cyclic data.

While the embodiment of the invention illustrated in FIG. 2 illustrates a corner cube reflecting element positioned at the center of flexures 411 and 412, other uses for the apparatus are also contemplated by the present invention. In accordance with alternative embodiments, the linear distance of other types of reflecting structures along an axis relative to a light source can also be controlled.

In other embodiments, in the alternative, the apparatus depicted in FIG. 4 can be used as a precision positioning apparatus without a retroreflector, for use in controlling the motion of parts in a precise fashion. This use of the present invention is particularly useful for optical lithography techniques, which are frequently employed in the fabrication of semiconductor devices. Owing to the extremely small size of features being fabricated during such lithographic processes, the position of the wafer relative to a light source must be determined with great precision. Therefore, alternative embodiments of the apparatus in accordance with the present invention control movement of a semiconductor wafer along an axis relative to a radiation source.

The invention has been described with particular illustrative embodiments. It is to be understood that the invention is not limited to the above-described embodiments and that various changes and modifications may be made by those of ordinary skill in the art without departing from the spirit and scope of the invention.

What is claimed is:

1. An apparatus for positioning a retroreflector, said apparatus comprising:
a retroreflector, wherein said retroreflector further comprises an effective aperture;
a retroreflector mount for holding said retroreflector, wherein said retroreflector mount further comprises a front end and a back end obverse to said front end, wherein said effective aperture is exposed through an opening in said front end;
a plurality of parallel radial flexures including a first radial flexure and a second radial flexure parallel to said first radial flexure, wherein said first radial flexure surrounds said front end, and wherein said second radial flexure surrounds said back end; and
an actuator for positioning said retroreflector,
wherein said plurality of parallel radial flexures allow for one-axis movement of said retroreflector of ±2.5 millimeters perpendicular to said plurality of parallel radial flexures, with an axial deviation of less than 0.001 radians.

2. An apparatus for positioning a retroreflector according to claim 1, wherein said first radial flexure is comprised of steel.

3. An apparatus for positioning a retroreflector according to claim 1, wherein said first radial flexure is comprised of aluminum.

4. An apparatus for positioning a retroreflector according to claim 1, wherein said first radial flexure is comprised of Invar.

5. An apparatus for positioning a retroreflector according to claim 1, wherein said first radial flexure is comprised of titanium.

6. An apparatus for positioning a retroreflector according to claim 1, wherein said actuator is a lead-zirconate-titanate (PZT) actuator.

7. An apparatus for positioning a retroreflector according to claim 1, wherein said actuator is a voice-coil actuator.

8. An apparatus for positioning a retroreflector according to claim 1, wherein said actuator is a linear motor.

9. An apparatus for positioning a retroreflector according to claim 1, further comprising a coupler, wherein said coupler connects said actuator to said back end.

10. An apparatus for positioning a retroreflector according to claim 1, wherein said first radial flexure is pinned to said retroreflector mount.

11. An apparatus for positioning a retroreflector according to claim 1, wherein said first radial flexure is clamped to said retroreflector mount.

12. An apparatus for positioning a retroreflector according to claim 1, wherein said first radial flexure includes a notched cutout pattern.

13. An apparatus for positioning a retroreflector according to claim 1, wherein said first radial flexure includes a spiral cutout pattern.

14. A precision positioning apparatus, said apparatus comprising:
a mount, wherein said mount further comprises a front end and a back end obverse to said front end;
a plurality of parallel radial flexures including a first radial flexure and a second radial flexure parallel to said first radial flexure, wherein said first radial flexure surrounds said front end, and wherein said second radial flexure surrounds said back end; and
an actuator for positioning said mount,
wherein said plurality of parallel radial flexures allow for one-axis movement of said mount of ±2.5 millimeters perpendicular to said plurality of parallel radial flexures, with an axial deviation of less than 0.001 radians.

15. A precision positioning apparatus according to claim 14, wherein said first radial flexure is comprised of steel.

16. A precision positioning apparatus according to claim 14, wherein said first radial flexure is comprised of aluminum.

17. A precision positioning apparatus according to claim 14, wherein said first radial flexure is comprised of Invar.

18. A precision positioning apparatus according to claim 14, wherein said first radial flexure is comprised of titanium.

19. A precision positioning apparatus according to claim 14, wherein said actuator is a lead-zirconate-titanate (PZT) actuator.

20. A precision positioning apparatus according to claim 14, wherein said actuator is a voice-coil actuator.

21. A precision positioning apparatus according to claim 14, wherein said actuator is a linear motor.

22. A precision positioning apparatus according to claim 14, further comprising a coupler, wherein said coupler connects said actuator to said back end.

23. A precision positioning apparatus according to claim 14, wherein said first radial flexure is pinned to said mount.

24. A precision positioning apparatus according to claim 14, wherein said first radial flexure is clamped to said mount.

25. A precision positioning apparatus according to claim 14, wherein said first radial flexure includes a notched cutout pattern.

26. A precision positioning apparatus according to claim 14, wherein said first radial flexure includes a spiral cutout pattern.

27. An apparatus for positioning a retroreflector, said apparatus comprising:
retroreflector means for reflecting light, wherein said retroreflector means further comprises an effective aperture;
mount means for holding said retroreflector means, wherein said mount means further comprises a front end and a back end obverse to said front end, wherein said effective aperture is exposed through an opening in said front end;
a plurality of parallel radial flexure means including a first radial flexure means and a second radial flexure means parallel to said first radial flexure means for supporting said mount means, wherein said first radial flexure means surrounds said front end, and wherein said second radial flexure means surrounds said back end; and
actuator means for positioning said retroreflector means,
wherein said plurality of parallel radial flexure means allow for one-axis movement of said retroreflector means of ±2.5 millimeters perpendicular to said plurality of parallel radial flexure means, with an axial deviation of less than 0.001 radians.

28. A precision positioning apparatus, said apparatus comprising:
mount means for holding a part, wherein said mount means further comprises a front end and a back end obverse to said front end;
a plurality of parallel radial flexure means for including a first radial flexure means and a second radial flexure means parallel to said first radial flexure means for supporting said mount means, wherein said first radial flexure means surrounds said front end, and wherein said second radial flexure means surrounds said back end; and
actuator means for positioning said mount means,
wherein said plurality of parallel radial flexure means allows for one-axis movement of said mount means of +2.5 millimeters perpendicular to said plurality of parallel radial flexure means, with an axial deviation of less than 0.001 radians.
